(19) United States
(12) Patent Application Publication
(10) Pub. No.: US 2010/0037066 A1
(43) Pub. Date: Feb. 11, 2010

(54) INFORMATION PROCESSING APPARATUS, METHOD, PROGRAM, AND INFORMATION PROCESSING SYSTEM

(76) Inventor: YASUO MIYABE, Tokyo (JP)

Correspondence Address: Mr. Jackson Chen, 6535 N. STATE HWY 161, IRVING, TX, 75039, US

(21) Appl. No.: 12/536,029

(22) Filed: Aug. 5, 2009

(30) Foreign Application Priority Data
Aug. 7, 2008 (JP) 203915/2008

(51) Int. Cl. G06F 12/14; H04L 9/00; G06F 12/00

(52) U.S. Cl. 713/189; 380/277; 711/166; 711/E12.001

(57) ABSTRACT

An information processing apparatus, comprising: a decryption request unit that issues a decryption request for decrypting a encrypted target program at the time of the start of execution of the target program; a decryption unit that receives said decryption request from said decryption request unit, decrypts said encrypted target program and writes the so-decrypted target program into a first memory; an erasure request unit that issues an erasure request for erasing said decrypted target program at the time of the completion of execution of the target program; and
an erasure unit that receives said erasure request from said erasure request unit and erases said decrypted target program from said first memory.

This application is based upon and claims the benefit of priority from Japanese Patent Application No. 2008-203915, filed on Aug. 7, 2008, the disclosure of which is incorporated herein in its entirety by reference.

### TECHNICAL FIELD

The present invention relates to an information processing apparatus, a method for executing a program, a program and an information processing system and in particular, relates to an information processing apparatus, a method for executing a program, a program and an information processing system which ensures security of a program.

### BACKGROUND ART

A processor having a secure memory is disclosed in Japanese Patent Application Publication No. 2004-272594 as a related art relating to prevention of falsification or analysis of data. In the processor disclosed in this patent application, the secure memory which is configured to be able to be referred to only when the processor operates in a kernel mode is provided in a processor chip. With this special processor, the security technology disclosed in the patent application (document 1) enables to prevent falsification of data and keep data secret by arranging data loaded into the secure memory.

Another security technology relating to prevention of falsification of a program is disclosed in Japanese Patent Application Publication No. 2000-187646 in which the program is self-deleted after the program has been executed. The technology disclosed in this patent application (document 2) enables to delete a program file just after the execution of the program ends, by repeatedly executing a file deletion instruction, using the specification in Windows (registered trademark), UNIX (registered trademark) or the like which stipulates that programs are not deleted until the execution of the programs ends.

A performance evaluation apparatus is disclosed in Japanese Patent Application Publication No. 1995-121409 as a related art which verifies whether a program has normally been executed. The performance evaluation apparatus disclosed in this patent application (document 3) can verify normality by measuring the execution time of a test program and comparing it with a standard execution time.

### SUMMARY

An exemplary object of the invention is to provide an information processing apparatus, a method for executing a program, a program and an information processing system of which unauthorized analysis or falsification to a program loaded in a memory can be prevented without using a special processor.

An information processing apparatus according to an exemplary aspect of the invention includes a decryption request unit that issues a decryption request for decrypting a encrypted target program at the time of the start of execution of the target program, a decryption unit that receives said decryption request from said decryption request unit, decrypts said encrypted target program and writes the so-decrypted target program into a first memory, an erasure request unit that issues an erasure request for erasing said decrypted target program at the time of the completion of execution of the target program and an erasure unit that receives said erasure request from said erasure request unit and erases said decrypted target program from said first memory.

A method according to an exemplary aspect of the invention includes issuing, from a decryption request unit to a decryption unit, a decryption request for decrypting a encrypted target program at the time of the start of execution of the target program, receiving said decryption request, decrypting said encrypted target program, writing the so-decrypted target program n into a memory, by said decryption unit, issuing, from an erasure request unit to an erasure unit, an erasure request for erasing said decrypted target program at the time of the completion of execution of the target program and receiving said erasure request, and erasing said decrypted target program from said memory, by said erasure unit.

A computer readable medium embodying a program according to an exemplary aspect of the invention, said program causing an information processing apparatus to perform a method, said method includes issuing, from a decryption request unit to a decryption unit, a decryption request for decrypting a encrypted target program at the time of the start of execution of the target program, receiving said decryption request, decrypting said encrypted target program, writing the so-decrypted target program n into a memory, by said decryption unit, issuing, from an erasure request unit to an erasure unit, an erasure request for erasing said decrypted target program at the time of the completion of execution of the target program and receiving said erasure request, and erasing said decrypted target program from said memory, by said erasure unit.

### BRIEF DESCRIPTION OF THE DRAWINGS

Exemplary features and advantages of the present invention will become apparent from the following detailed description when taken with the accompanying drawings in which:

FIG. 1 is an exemplary block diagram showing a configuration of an information processing apparatus according to a first exemplary embodiment;

FIG. 2 is a figure showing a structure of information stored in a memory in a first and a second exemplary embodiment;

FIG. 3 is an exemplary flowchart showing operation of an information processing apparatus according to a first exemplary embodiment;

FIG. 4 is a block diagram showing a characteristic configuration of a first exemplary embodiment.

FIG. 5 is an exemplary block diagram showing a configuration of an information processing apparatus according to a second exemplary embodiment;

FIG. 6 is an exemplary flowchart showing operation of an information processing apparatus according to a second exemplary embodiment;

FIG. 7 is an exemplary block diagram showing a configuration of an information processing apparatus according to a third exemplary embodiment;

FIG. 8 is a figure showing a structure of information stored in a storage device of a server in a third exemplary embodiment.

### EXEMPLARY EMBODIMENT

Next, an exemplary embodiment will be described. Further, with respect to the technical terms used in the following description, in general, a program to be secured and a decrypted secure program can be called a target program, a CPU (Central Processing Unit) can be called a processor, and a firmware storage unit can be called a firmware area. Similarly, in general, decryption abnormality and execution abnormality can be called abnormality, an information processing apparatus can be called a first information processing apparatus, and a server can be called a second information processing apparatus.

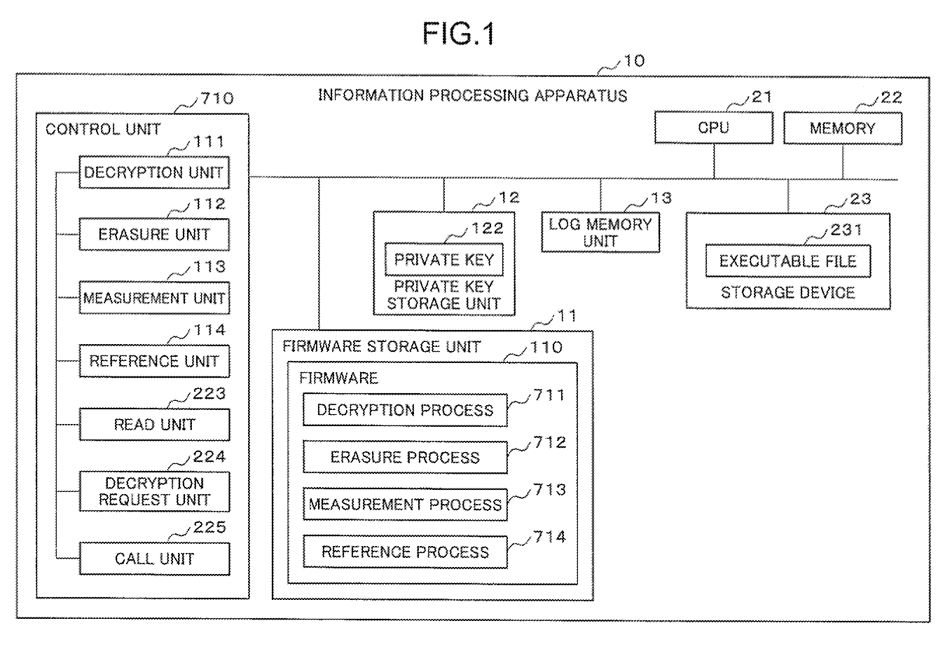

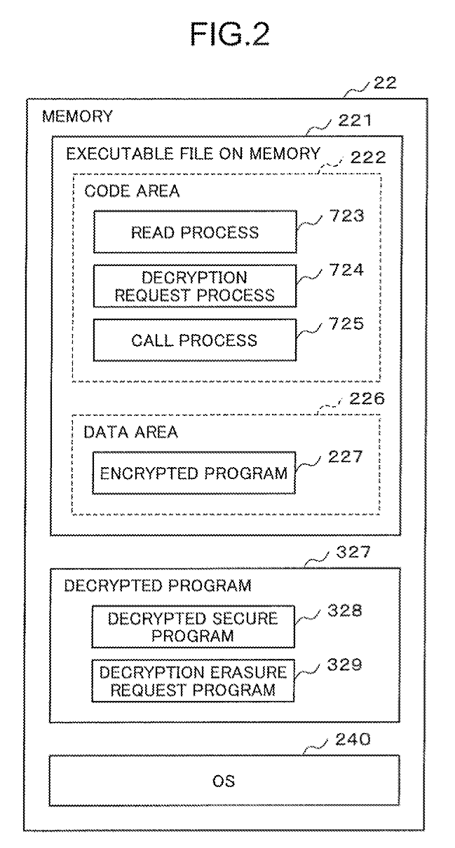

Referring to FIG. 1 and FIG. 2, information processing apparatus 10 in the first exemplary embodiment includes firmware storage unit 11, private key storage unit 12, log memory unit 13, CPU 21, memory 22, storage device 23 and control unit 710.

Firmware storage unit 11 is storage means (for example, a PROM (Programmable Read Only Memory) or the like), falsification of the contents of which cannot be achieved easily.

Firmware 110 is stored in firmware storage unit 11 and includes decryption process 711, erasure process 712, measurement process 713 and reference process 714 which are programs. The respective programs for the respective processes included in firmware 110 are executed by CPU 21.

Private key storage unit 12 is, for example, a register or a PROM of hardware, and it is a storage unit whose contents can be read out only by decryption unit 111.

Log memory unit 13 is, for example, a register of hardware, whose contents can be written only by decryption unit 111 and measurement unit 113 and can be read out only by reference unit 114.

CPU 21 executes firmware 110, each process in code area 222 in executable file 221, decrypted program 327 and OS (Operating System) 240.

As shown in FIG. 2, memory 22 stores executable file 221, decrypted program 327 and OS 240 as data that can be read out by CPU 21.

Executable file 221 includes code area 222 and data area 226.

Code area 222 includes read process 723, decryption request process 724 and call process 725.

Data area 226 includes encrypted program 227.

Encrypted program 227 is a program created by encrypting decrypted program 327, using an encryption key with which encryption that can be decrypted by private key 122 is performed.

Decrypted program 327 includes decrypted secure program 328 and decryption erasure request program 329.

Decrypted secure program 328 is a target program, confidentiality and integrity of the contents of which have to be ensured.

Decryption erasure request program 329 is a program for requesting erasure unit 112 mentioned hereinafter to erase decrypted program 327 on memory 22.

OS 240 operates on CPU 21 and controls the operation of whole information processing apparatus 10.

Storage device 23 is for example, a magnetic disk device or the like and stores executable file 231.

Executable file 231 includes encrypted program 227, is loaded in memory 22 by OS 240 and is executed by CPU 21.

Control unit 710 includes decryption unit 111, erasure unit 112, measurement unit 113, reference unit 114, read unit 223, decryption request unit 224 and call unit 225. Decryption unit 111, erasure unit 112, measurement unit 113 and reference unit 114 are realized by performing decryption process 711, erasure process 712, measurement process 713 and reference process 714 by CPU 21, respectively. Read unit 223, decryption request unit 224 and call unit 225 are realized by performing read process 723, decryption request process 724 and call process 725 by CPU 21, respectively.

Decryption unit 111 reads out private key 122 from private key storage unit 12, and decrypts encrypted program 227 loaded in memory 22 by using private key 122. Decryption unit 111 judges whether or not decryption of encrypted program 227 is normally performed and instructs measurement unit 113 to start measurement when the decryption is normally performed.

Erasure unit 112 instructs measurement unit 113 to end the measurement and erases a content in a specified area of memory 22. Erasure unit 112 realizes the erasure by overwriting all the area specified by memory 22 with “0”.

Measurement unit 113 receives an instruction for starting the measurement and an instruction for ending the measurement and measures the time between two instructions as an execution-time-to-be-verified. The time between the instruction for starting the measurement and the instruction for ending the measurement, which was measured in a state in which any analysis, falsification or the like of the contents of decrypted secure program 328 and decryption erasure request program 329 had not been made, is in advance given to measurement unit 113 as an expected value execution time and stored in measurement unit 113. Measurement unit 113 compares the execution-time-to-be-verified with the expected value execution time, judges that analysis or falsification of a program was made when the difference between them exceeds a predetermined range and keeps a record indicating that an unauthorized process was performed, in log memory unit 13. Here, the predetermined range may be, for example, a time of 5% of the expected value execution time.

Reference unit 114 reads out the record in log memory unit 13.

Read unit 223 loads encrypted program 227 in data area 226 of memory 22. Decryption request unit 224 requests decryption unit 111 to decrypt encrypted program 227. Call unit 225 calls decrypted secure program 328.

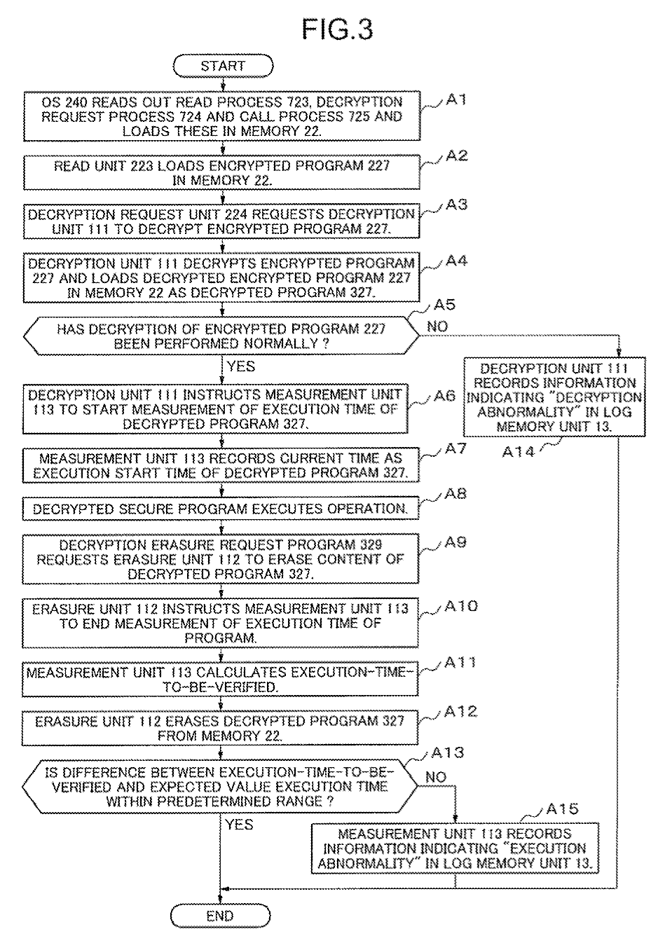

Next, the operation of the first exemplary embodiment will be described in more detail with reference to FIGS. 1 to 3. FIG. 3 shows the operation of information processing apparatus 10.

First, OS 240 reads out read process 723, decryption request process 724 and call process 725 that are executable files 231 stored in storage device 23 and loads these in code area 222 of memory 22 (Step A1).

Next, read unit 223 loads encrypted program 227 that is executable file 231 in data area 226 of memory 22 (Step A2).

Next, decryption request unit 224 gives the head address and the size of encrypted program 227 loaded in memory 22 in step A2 to decryption unit 111 and requests the decryption of decrypt encrypted program 227 (Step A3).

Decryption unit 111 reads out private key 122 from private key storage unit 12 in response to the request to decrypt encrypted program 227 in step A3, and decrypts encrypted program 227 specified by the given size and the given head address, using private key 122. Decryption unit 111 loads decrypted encrypted program 227 in memory 22 as decrypted program 327 (Step A4).

Next, decryption unit 111 judges whether or not the decryption of encrypted program 227 has been performed normally (Step A5). For example, decryption unit 111 may judge normality of decrypted program 327 according to a check code included in decrypted program 327 or the like.

When the decryption of encrypted program 227 is not normally performed (“No” judgment in step A5), decryption unit 111 records information indicating “decryption abnormality” in log memory unit 13 (Step A14), and ends the process.

When the decryption of encrypted program 227 is normally performed in step A5 (“Yes” judgment in step A5), decryption unit 111 instructs measurement unit 113 to start measurement of the execution time of decrypted program 327 (Step A6). Upon receipt of the instruction for starting measurement, measurement unit 113 records the current time as an execution start time of decrypted program 327 (Step A7). Here, the current time may be acquired from OS 240 or measurement unit 113 may have a timer function.

Next, call unit 225 calls out decrypted secure program 328 and the called-out decrypted secure program 328 executes an operation (Step A8).

Next, decryption erasure request program 329 requests erasure unit 112 to erase the contents of decrypted program 327 (Step A9).

Erasure unit 112 first instructs measurement unit 113 to end the measurement of the execution time of decrypted program 327 in response to the request to erase the content of decrypted program 327 in step A9 (Step A10). Measurement unit 113 then calculates the execution-time-to-be-verified on the basis of the difference between the execution start time of decrypted program 327 recorded in step A7 and the current time (the difference can be regarded as the time spent for the execution of decrypted program 327) (Step A11).

Then, erasure unit 112 erases the contents of decrypted program 327 on memory 22 (Step A12).

Next, measurement unit 113 compares the execution-time-to-be-verified calculated in step A11 with the expected value execution time of decrypted program 327 stored in measurement unit 113 and judges whether or not the difference between them is within a predetermined range (Step A13). When the difference between them is not within the predetermined range (“No” judgment in step A13), measurement unit 113 records information indicating “execution abnormality” in log memory unit 13 (Step A15) and ends the process. When the difference is within the predetermined range (“Yes” judgment in step A13), measurement unit 113 ends the process.

Further, reference unit 114 reads out the contents of log memory unit 13 and outputs the contents to OS 240 and another means (not shown, for example, man-machine interface or the like). An operator receives the contents of log memory unit 13 via OS 240 and the man-machine interface, and can judge that the falsification of the contents of encrypted program 227 has been made, by confirming that the contents of log memory unit 13 indicates “decryption abnormality” or can judge that analysis or falsification of decrypted program 327 has been made, by confirming that the contents of log memory unit 13 indicates “execution abnormality”.

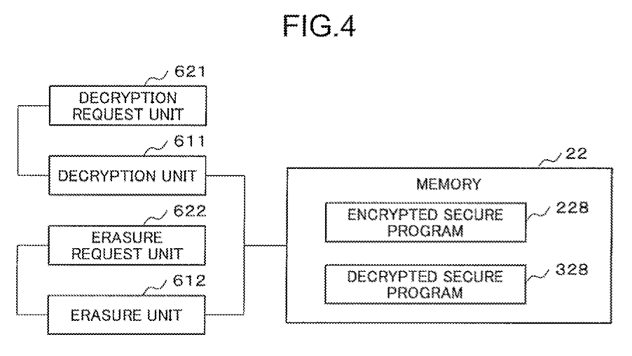

FIG. 4 shows a characteristic construction of the exemplary embodiment.

Encrypted secure program 228 is a program obtained by encrypting program-to-be-secured 800 (not shown, for example, an application program or the like that has to be secured against unauthorized analysis or falsification).

Decrypted secure program 328 is a program obtained by decrypting encrypted secure program 228 and the contents of decrypted secure program 328 is the same as those of program-to-be-secured 800 that is the original program of encrypted secure program 228.

Decryption request unit 621 requests Decryption unit 611 to decrypt encrypted secure program 228 corresponding to program-to-be-secured 800 at the start time of execution of program-to-be-secured 800.

Decryption unit 611 receives the decryption request, decrypts encrypted secure program 228, and writes the so-decrypted program into memory 22 as decrypted secure program 328.

Erasure request unit 622 requests Erasure unit 612 to erase decrypted secure program 328 at the time of the completion of execution of decrypted secure program 328.

Erasure unit 612 receives the erasure request and erases decrypted secure program 328 written in memory 22.

The exemplary embodiment has a first effect in which unauthorized analysis or falsification of a program can be made difficult because the program does not exist for a long time in a state in which analysis or falsification of the program can be made. The reason is that the program encrypted is decrypted just before executing the program, and that when the execution of the decrypted program is completed, the program is erased immediately.

The exemplary embodiment has a second effect in which unauthorized analysis or falsification of a program loaded in memory can be detected. The reason is that the occurrence of abnormality can be detected by comparing the time period from the time point of completion of the decryption of decrypted program 327 to the time point of start of the erasure of decrypted program 327 with an expected value execution time.

Next, a second exemplary embodiment will be described in detail with reference to the drawings.

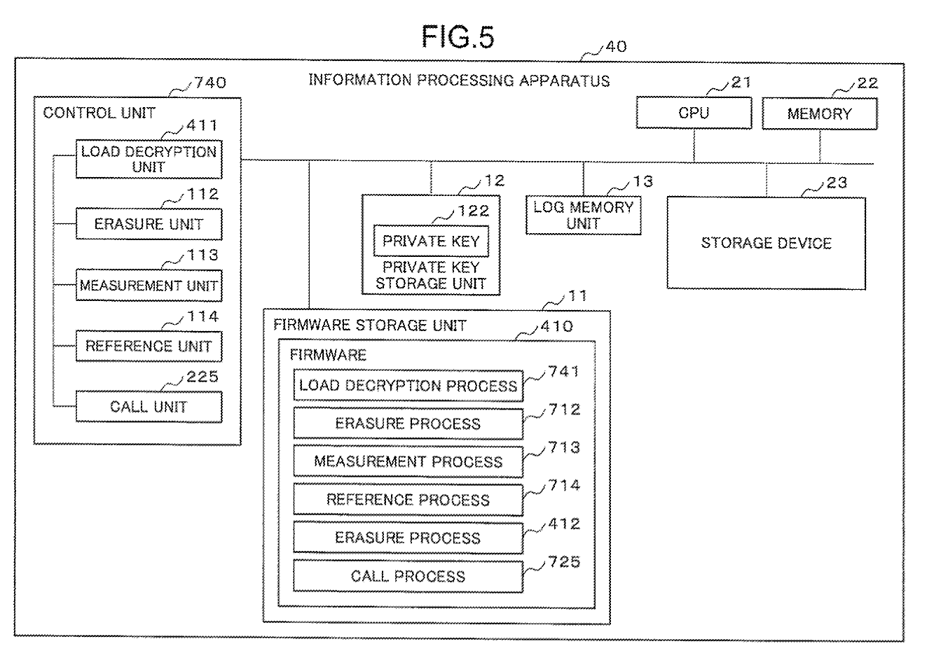

Referring to FIG. 5, in addition to the structural elements of firmware 110 in information processing apparatus 10 in the first exemplary embodiment in FIG. 1, firmware 410 in information processing apparatus 40 in the second exemplary embodiment includes load decryption process 741 instead of decryption process 711 in FIG. 1, call process 725 and encrypted program 412. Similarly, control unit 740 includes load decryption unit 411 instead of decryption unit 111, and does not includes read unit 223 and decryption request unit 224. Additionally, storage device 23 does not includes executable file 231 including encrypted program 226. Load decryption unit 411 may be realized by performing load decryption process 741 by CPU 21.

Load decryption unit 411 loads encrypted program 412 in memory 22 and decrypts encrypted program 412 loaded in memory 22, using private key 122.

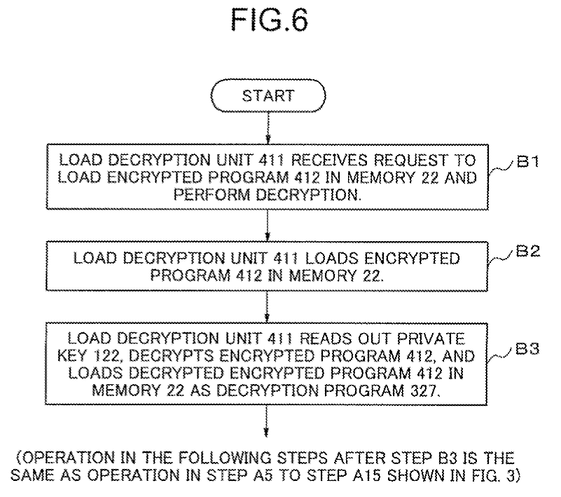

Next, an operation of the second exemplary embodiment will be described in detail with reference to FIG. 5 and FIG. 6. FIG. 6 shows the operation of information processing apparatus 40.

First, load decryption unit 411 in firmware 410 receives a request for loading encrypted program 412 in memory 22 and performing decryption from means (not shown) (Step B1).

The means (not shown) for issuing this request may be an executable file (not shown) which is loaded in memory 22 from storage device 23 and executed by OS 240 and also may be instruction means (not shown) in firmware 410.

Next, load decryption unit 411 loads encrypted program 412 of firmware 410 in memory 22 (Step B2). Then, load decryption unit 411 reads out private key 122 from private key storage unit 12 and decrypts encrypted program 412 loaded in memory 22, using private key 122. Load decryption unit 411 loads decrypted encrypted program 412 in memory 22 as decrypted program 327 (Step B3).

The operations in the steps following step B3 are the same as the operations in step A5 to step A15 in the first exemplary embodiment.

Load decryption unit 411 may decrypt encrypted program 412 of firmware 410 with private key 122 and generate decrypted program 327 in step B3 without carrying out the process in step B2.

The exemplary embodiment has a first effect in which falsification of a program can be made more difficult. The reason is that firmware includes an encrypted program. The exemplary embodiment has a second effect in which the time which it takes until the program starts can be reduced. The reason is that the encrypted program in the firmware is directly decrypted.

Next, the third exemplary embodiment will be described in detail with reference to the drawings.

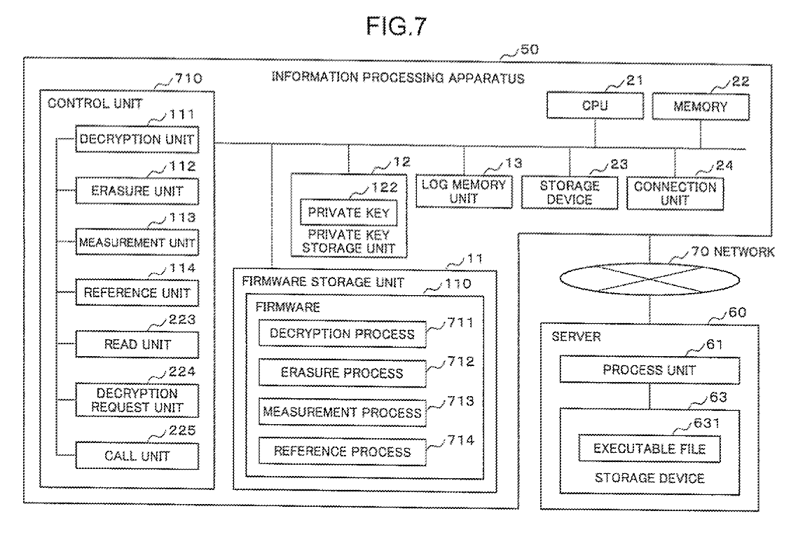

Referring to FIG. 7, information processing apparatus 50 in the third exemplary embodiment does not include executable file 231 in storage device 23 and includes connection unit 24 in comparison with information processing apparatus 10 in the first exemplary embodiment shown in FIG. 1. Information processing apparatus 50 is connected with server 60 via network 70. Server 60 is, for example, a computer or a network disk device and includes process unit 61 and storage device 63.

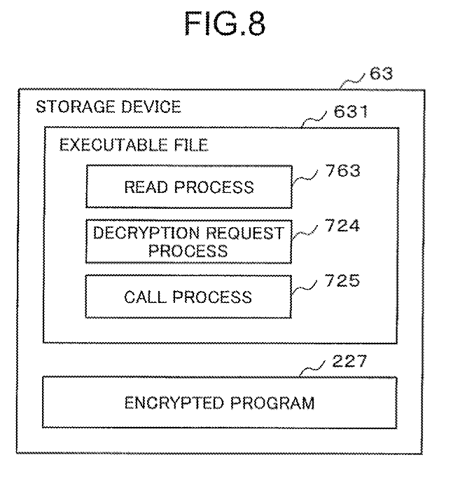

FIG. 8 shows the structure of information stored in storage device 63.

Next, the operation of the third exemplary embodiment will be described in detail with reference to FIG. 3, FIG. 7 and FIG. 8.

The operations in steps A1 and A2 in the third exemplary embodiment is different from the operations in steps A1 and A2 in the first exemplary embodiment shown in FIG. 3.

The operation in step A1 in the third exemplary embodiment corresponding to step A1 shown in FIG. 3 is as follows. OS 240 reads out read process 763, decryption request process 724 and call process 725 that are executable files 631 stored in storage device 63 of server 60 via network 70 by using connection unit 24. Then, OS 240 loads read process 763, decryption request process 724 and call process 725 that are read out and executable files 631 in code area 222 of memory 22. Read unit 223 may be realized by performing read process 763 by CPU 21.

The operation in step A2 in the third exemplary embodiment corresponding to step A2 shown in FIG. 3 is as follows. Read unit 223 reads out encrypted program 227 that is executable file 631 stored in storage device 63 of server 60 via network 70 by using connection unit 24. Then, read unit 223 loads read encrypted program 227 in data area 226 of memory 22.

The explanation of the operations performed in the steps after step A3 is omitted because it is the same as that of the first exemplary embodiment

The exemplary embodiment has the same effect as the first exemplary embodiment even when the encrypted secure program exists at a separated place. The reason is that the executable file can be read via a network.

In the security technology disclosed in document 1 mentioned above, a secure memory is needed in a processor and an external memory has to be connected to the processor through an encrypted communication path by using a protocol whose analysis is difficult. Therefore, the technology has a problem that it cannot be realized without using a very special processor.

The security technology described in document 2 mentioned above has a problem that protection against falsification of a program loaded in a memory is insufficient.

Additionally, the technology for verifying whether a program is normally executed that is described in document 3 mentioned above has a problem that protection against alternation of the result of measurement of an execution time is insufficient.

Each of the exemplary embodiments mentioned above can be applied to an apparatus or a system which executes a program that processes the information of which confidentiality and integrity has to be ensured. That is because for example, in a case in which accounting is performed according to information collected or outputted by a program or the like, confidentiality and integrity of the content has to be ensured with respect to not only the information but also the program.

Additionally, each of the exemplary embodiments mentioned above can be used to prevent abuse of information or realize a function of copyright protection.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty.

Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. An information processing apparatus, comprising:
a decryption request unit that issues a decryption request for decrypting a encrypted target program at the time of the start of execution of the target program;
a decryption unit that receives said decryption request from said decryption request unit, decrypts said encrypted target program and writes the so-decrypted target program into a first memory;
an erasure request unit that issues an erasure request for erasing said decrypted target program at the time of the completion of execution of the target program; and
an erasure unit that receives said erasure request from said erasure request unit and erases said decrypted target program from said first memory.

2. The information processing apparatus according to claim 1, further comprising:
a processor; and
a firmware area,
wherein at least one of said decryption unit and said erasure unit is realized by executing a program stored in said firmware area on said processor.

3. The information processing apparatus according to claim 1, further comprising:
a private key storage unit that stores a private key for decrypting said target program;
a storage unit that stores one or more executable files including said encrypted target program; and
a second memory in which said one or more executable files are loaded.

4. The information processing apparatus according to claim 1, further comprising:
a measurement unit that measures the time period from the time point of completion of the decryption of said encrypted target program to the time point of start of the erasure of said decrypted target program as an execution-time-to-be-verified of the target program, compares the measured time period with an predetermined expected value execution time of the target program, and judges on the basis of that result of comparison whether or not abnormality has occurred.

5. The information processing apparatus according to claim 4, further comprising:
a second processor; and
a second firmware area,
wherein said measurement unit is realized by executing a program stored in said second firmware area on said second processor.

6. The information processing apparatus according to claim 4, further comprising:
a log memory unit that memorizes the judgment result by said measurement unit of whether or not abnormality has occurred; and
a reference unit that refers to the contents of said log memory unit.

7. A method, comprising:
issuing, from a decryption request unit to a decryption unit, a decryption request for decrypting a encrypted target program at the time of the start of execution of the target program;
receiving said decryption request, decrypting said encrypted target program, writing the so-decrypted target program n into a memory, by said decryption unit;
issuing, from an erasure request unit to an erasure unit, an erasure request for erasing said decrypted target program at the time of the completion of execution of the target program; and
receiving said erasure request, and erasing said decrypted target program from said memory, by said erasure unit.

8. The method according to claim 7, further comprising:
measuring the time period from the time point of completion of the decryption of said encrypted target program to the time point of start of the erasure of said decrypted target program as an execution-time-to-be-verified of the target program, comparing said time period with an predetermined expected value execution time of the target program, and judging on the basis of that result of comparison whether or not abnormality has occurred.

9. A computer readable medium recording thereon embodying a program, enabling a computer to:
issue, from a decryption request unit to a decryption unit, a decryption request for decrypting a encrypted target program at the time of the start of execution of the target program;
receive said decryption request, decrypt said encrypted target program, write the so-decrypted target program into a memory, by said decryption unit;
issue, from an erasure request unit to an erasure unit, an erasure request for erasing said decrypted target program at the time of the completion of execution of the target program; and
receive said erasure request, and erase said decrypted target program from said memory, by said erasure unit.

10. The program according to claim 9, further enabling a computer to:
measure the time period from the time point of completion of the decryption of said encrypted target program to the time point of start of the erasure of said decrypted target program as an execution-time-to-be-verified of the target program, compare said time period with an predetermined expected value execution time of the target program, and judge on the basis of that result of comparison whether or not abnormality has occurred.

11. An information processing system, comprising:
a first information processing apparatus and a second information processing apparatus that are connected with each other via a network, wherein
said first information processing apparatus is the information processing apparatus according to claim 1 which further includes a connection unit to a network, and
said second information processing apparatus stores said encrypted target program.

12. An information processing apparatus, comprising:
a decryption request means for issuing a decryption request for decrypting a encrypted target program at the time of the start of execution of the target program;
a decryption means for receiving said decryption request from said decryption request means, decrypting said encrypted target program and writing the so-decrypted target program into a memory;
an erasure request means for issuing an erasure request for erasing said decrypted target program at the time of the completion of execution of the target program; and
an erasure means for receiving said erasure request from said erasure request means and erasing said decrypted target program from said memory.
